(19) United States
(12) Patent Application Publication
(10) Pub. No.: US 2004/0046327 A1
(43) Pub. Date: Mar. 11, 2004

(54) Labyrinth/brush seal combination

(76) Inventors: Robert P. Menendez, Exeter, RI (US); Howard King, Riverside, RI (US)

Correspondence Address: Iandiorio & Teska, 260 Bear Hill Road, Waltham, MA, 02451-1018, US

(21) Appl. No.: 10/331,233

(22) Filed: Dec. 30, 2002

Related U.S. Application Data
(60) Provisional application No. 60/408,273, filed on Sep. 5, 2002.

(51) Int. Cl. F16J 15/447

(52) U.S. Cl. 277/412

(57) ABSTRACT

A labyrinth/brush seal combination and method wherein a brush seal includes a retainer and a plurality of bristles extending therefrom, a labyrinth seal includes a plurality of teeth, and a slot is formed between adjacent teeth. The retainer of the brush seal is disposed in the slot formed in the labyrinth seal, a first tooth of the labyrinth seal forms the front plate of the brush seal, and a second, adjacent tooth of the labyrinth seal forms the back plate of the brush seal.

### PRIORITY CLAIM

This application claims priority of U.S. Provisional Application No. 60/408,273, filed Sep. 5, 2002.

### FIELD OF THE INVENTION

This invention relates to a combined labyrinth/brush seal useful in rotary machines such as turbines.

### BACKGROUND OF THE INVENTION

Rotary machines such as turbines typically include labyrinth seals disposed between a stationary housing and rotating shaft. The labyrinth seal has a plurality of teeth the tips of which are closely spaced with features of the rotating shaft forcing fluid to follow a tortuous path whereby a pressure drop is created. While labyrinth seals have proved to be quite reliable, their performance degrades over time as a result of transient events in which the stationary and rotating components interfere rubbing the labyrinth teeth into a “mushroom” profile and opening the seal clearance.

Brush seals, on the other hand, which typically include a front plate, a back plate, and a plurality of bristles sandwiched therebetween are generally less prone to leakage than labyrinth seals. Brush seals can also accommodate relative radial movement between fixed and rotational components, for example, between a rotor and a stator, because of the flexure of the seal bristles. Brush seals also generally conform better to surface non-uniformities. Thus, brush seals sustain rotary machine performance better than is generally possible with labyrinth seals. Brush seals, however, do wear and must be replaced. Moreover, many existing rotary machines are already fitted with labyrinth seals and cannot be retrofitted with brush seals alone.

Thus, those skilled in the art have attempted to incorporate brush seals into labyrinth seals, typically at the time the labyrinth seal is removed from the machine and either refurbished or replaced with a new labyrinth seal.

For example, in U.S. Pat. No. 6,250,640, incorporated herein by this reference, a slot is formed in a labyrinth seal so a complete brush seal including a front and back plate can be incorporated into the labyrinth seal. See also U.S. Pat. No. 6,286,211 also incorporated herein by this reference.

In U.S. Pat. No. 6,257,586, one or more of the labyrinth seal teeth are removed and the back plate of the brush seal is specially formed to have the profile of one of the removed labyrinth seal teeth. The front plate of the brush seal is conventional and, after the brush seal is specially fabricated with the conventional front plate and the back plate having the profile of a labyrinth seal tooth, the brush seal is welded in a slot formed in the labyrinth seal. U.S. Pat. No. 6,257,586 is hereby incorporated herein by this reference.

When a complete brush seal assembly is inserted into a labyrinth seal in accordance with the known prior art, the back plate must be configured with a profiled tip set at an appropriate clearance from the rotor to ensure proper brush seal performance characteristics. This feature is important as the back plate should not be allowed to contact the rotating shaft. The result is that the brush seal design is specific for each particular application. The same is true with respect to the front plate: it must have the appropriate amount of clearance both axially relative to the bristle pack and radially relative to the seal inside diameter. Moreover, the side plate features, when joined with the bristle pack, result in a curved segment with sufficient bending rigidity to make it impractical to apply it to a wide range of labyrinth seal housing diameters. Thus, each brush seal is custom designed for each specific application at a great cost.

Thus labyrinth/brush seal combinations have not gained wide acceptance in the industry primarily because labyrinth seals of different configurations each require a different type of brush seal which must be specially manufactured at a great cost. The tooling for a specific front and back plate configuration, for example, can cost thousands of dollars.

### BRIEF SUMMARY OF THE INVENTION

It is therefore an object of this invention to provide a combined labyrinth/brush seal at a lower cost.

It is a further object of this invention to provide such a labyrinth/brush seal combination using a single brush seal design for many different labyrinth seal configurations.

It is a further object of this invention to provide a method of making a labyrinth/brush seal combination either for a labyrinth seal already in service or for a new labyrinth seal.

It is a further object of this invention to provide a combined labyrinth/brush seal in which the back plate for the brush seal has the profile of a labyrinth seal tooth but without having to manufacture a specially designed back plate for the brush seal.

It is a further object of this invention to provide a labyrinth/brush seal combination in which the brush seal element is replaceable.

It is a further object of this invention to provide a brush seal component which is standardized and applicable to a wide range of labyrinth seal diameters.

It is a further object of this invention to provide a brush seal with a smaller radial and axial cross-section so less space is required when compared to a complete brush seal allowing for the application of improved sealing on a broader basis.

It is a further object of this invention to provide a brush seal which offers improved performance while at the same time retaining the presence of adjacent labyrinth seal teeth to provide sealing redundancy and greater performance reliability.

The invention results from the realization that a better labyrinth/brush seal combination is effected by a brush seal without a front plate or back plate disposed in a labyrinth seal at a location such that the existing adjacent labyrinth seal teeth serve as the front and back plate of the brush seal.

This invention features a labyrinth/brush seal combination comprising a brush seal including a retainer and a plurality of bristles extending therefrom, a labyrinth seal including a plurality of teeth, and a slot formed between adjacent teeth. The retainer of the brush seal is disposed in the slot formed in the labyrinth seal, a first tooth of the labyrinth seal forms the front plate of the brush seal, and a second, adjacent tooth of the labyrinth seal forms the back plate of the brush seal.

In the preferred embodiment, the retainer has a moment of inertia of approximately 5×10⁻⁵ inches⁴ or less, and the bristles of the brush seal abut the second tooth and are spaced from the first tooth. In one example, a pin extends into the labyrinth seal for removably securing the retainer of the brush seal in the slot.

Typically, the slot defines first and second parallel walls and the second parallel wall overlaps the second tooth forming a straight back plate. And, the slot terminates in an offset extending over the second tooth to position the bristles in an abutting relationship with the second tooth.

The bristles may extend outward from the first and second teeth, the slot may have a width less than or equal to the space between adjacent labyrinth teeth, or the slot may have width greater than the space between adjacent labyrinth teeth.

One labyrinth/brush seal combination in accordance with this invention includes a brush seal including a retainer having a moment of inertia of approximately 5×10⁻⁵ inches⁴ or less and a plurality of bristles extending therefrom, a labyrinth seal including a plurality of teeth and a slot formed between adjacent teeth, the retainer of the brush seal disposed in the slot of the labyrinth seal, and one existing tooth of the labyrinth seal forming the back plate of the brush seal.

Another labyrinth/brush seal combination in accordance with this invention features a brush seal including a retainer and a plurality of bristles extending therefrom, a labyrinth seal including a plurality of teeth and a slot formed between adjacent teeth, the slot defining first and second parallel walls, the second wall overlapping one tooth of the labyrinth seal forming a straight back plate for the bristles of the brush seal, the slot terminating in an offset extending over said tooth, and the retainer of the brush seal disposed in the slot of the labyrinth seal and the bristles of the brush seal abutting said tooth.

This invention also features a method of making a labyrinth/brush seal combination comprising forming a slot between first and second teeth of a labyrinth seal, assembling a brush seal to include a retainer and a plurality of bristles extending therefrom but lacking a front or back plate, and disposing the retainer of the brush seal in the slot so that the first tooth of labyrinth seal forms the front plate of the brush seal and the second tooth of the labyrinth seal forms the back plate of the labyrinth seal.

Preferably, the retainer is designed to have a moment of inertia of approximately 5×10⁻⁵ inches⁴ or less, and the bristles are made to abut the second tooth and to be spaced from the first tooth. In one example, a channel is formed in the labyrinth seal and placing a pin in the channel for securing the retainer of the brush seal in the slot. Typically, the second tooth of the labyrinth seal is cut to form a straight back plate for the brush seal and an offset is machined extending over the second tooth.

One method of making a labyrinth/brush seal combination in accordance with this invention includes forming a slot between adjacent teeth of a labyrinth seal, assembling a brush seal to include a retainer having a moment of inertia approximately 5×10⁻⁵ inches⁴ or less and a plurality of bristles extending therefrom but lacking a back plate, and disposing the retainer of the brush seal in the slot so that an existing tooth of the labyrinth seal forms the back plate of the brush seal.

Another method of making a labyrinth/brush seal combination includes forming a slot between adjacent teeth of a labyrinth seal and cutting one said tooth to form a straight back plate, assembling a brush seal to include a retainer and a plurality of bristles extending therefrom but lacking a back plate, and disposing the retainer of the brush seal in the slots so that the bristles of the brush seal abut the cut second tooth of the labyrinth seal.

### BRIEF DESCRIPTION OF THE DRAWINGS

Other objects, features and advantages will occur to those skilled in the art from the following description of a preferred embodiment and the accompanying drawings, in which:

FIG. 1 is a schematic three dimensional view of a typical prior art labyrinth seal;

FIG. 2 is a schematic three dimensional view showing the labyrinth seal of FIG. 1 with a slot formed therein to receive a specially manufactured brush seal in accordance with the prior art;

FIG. 3 is a cross-sectional view showing a specially configured brush seal incorporated into a labyrinth seal in accordance with the prior art;

FIG. 4 is cross-sectional view showing still another specially manufactured brush seal in accordance with the prior art;

FIG. 5 is a cross-sectional view showing the specially manufactured brush seal of FIG. 4 incorporated into a labyrinth seal;

FIG. 6 is a cross-sectional view showing one preferred brush seal element of the combined labyrinth/brush seal of the subject invention;

FIGS. 7-9 are schematic cross-sectional views showing one example of the method of making a labyrinth/brush seal combination in accordance with the subject invention;

FIGS. 10-13 are schematic views of a prototype labyrinth/brush seal combination of the subject invention; and

FIGS. 14-16 are cross-sectional views showing how the unique brush seal of the subject invention can be incorporated with different labyrinth seal configurations.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

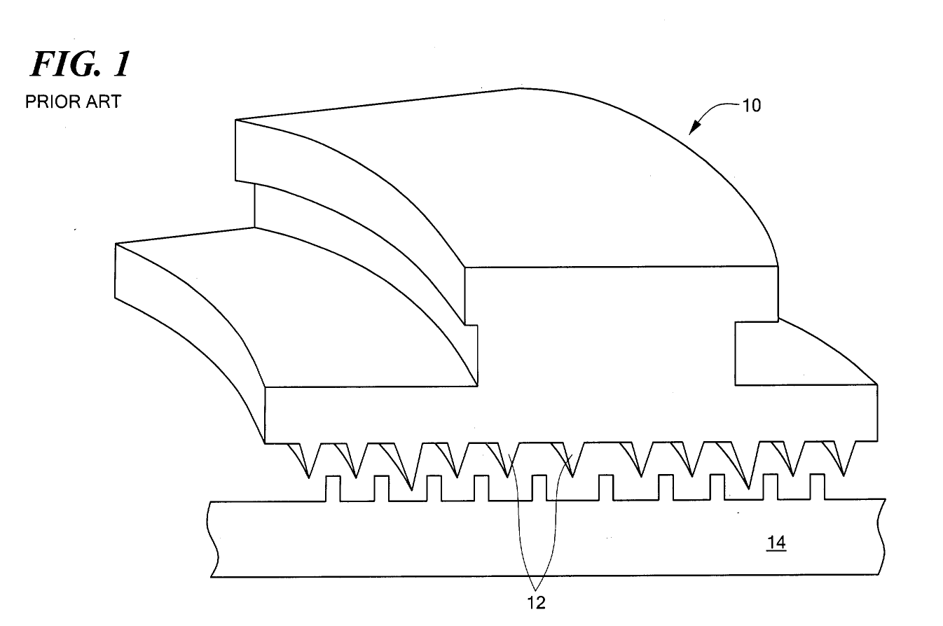

FIG. 1 shows labyrinth seal 10 having teeth 12 closely spaced with various features of rotating shaft 14 forcing fluid to follow a tortuous path whereby a pressure drop is created. In other designs, a rotating shaft 14 is featureless and in still other designs teeth 12 have a “hi-lo” design.

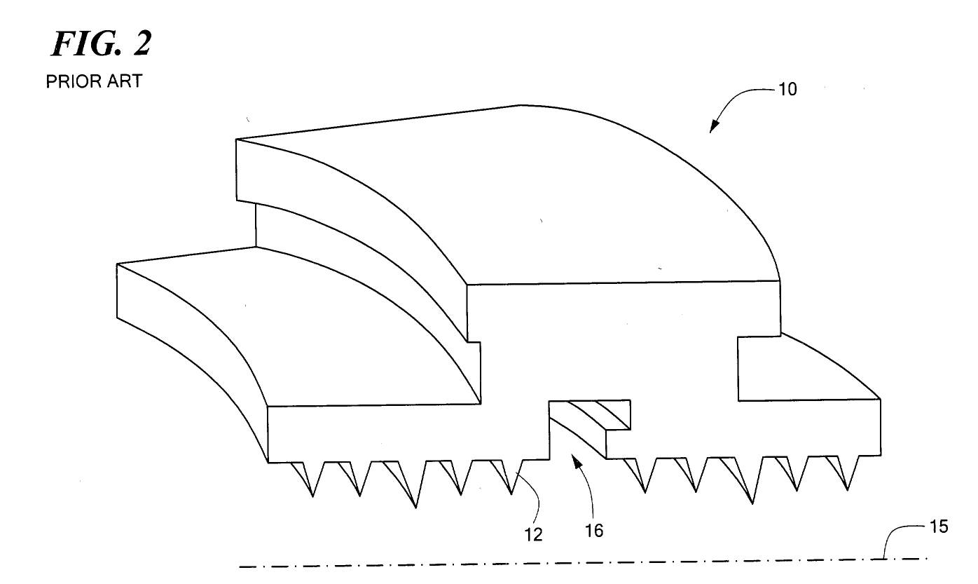

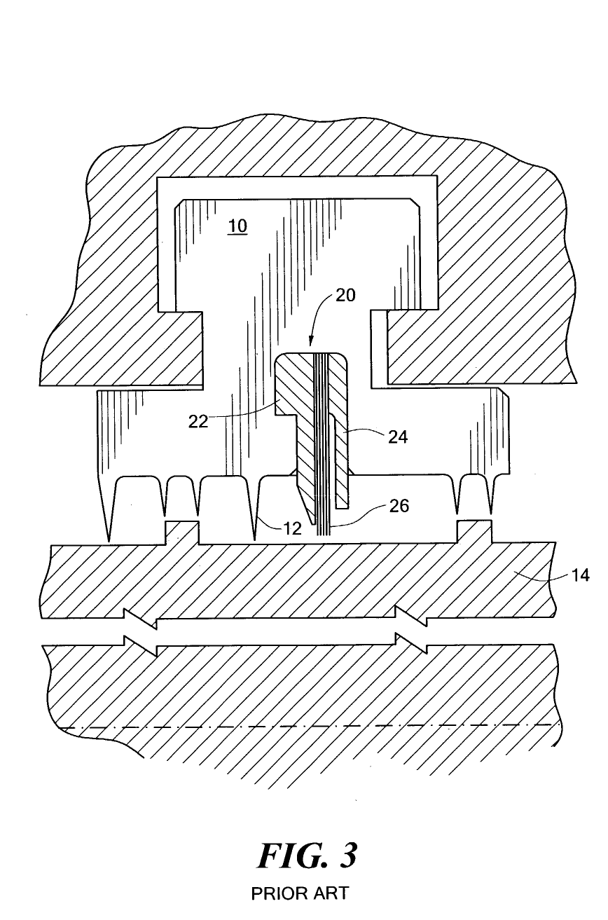

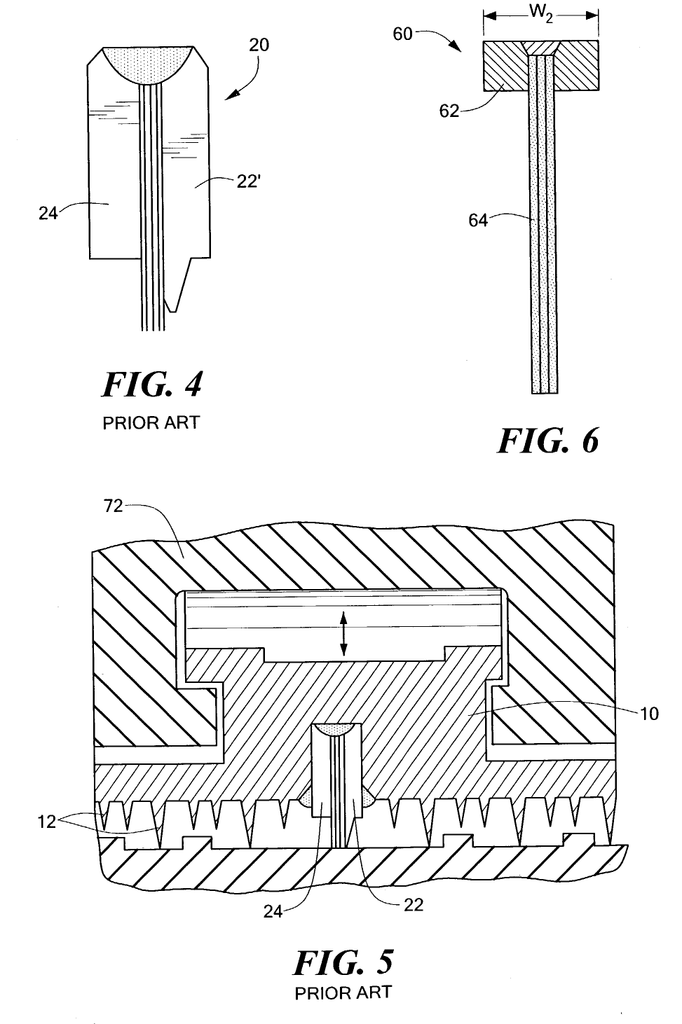

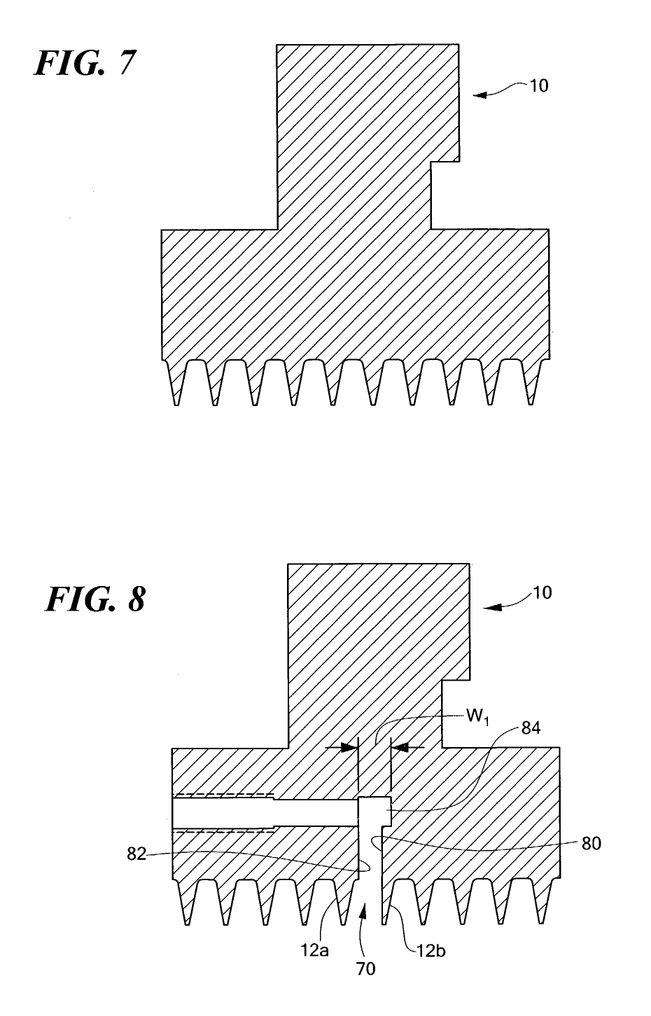

In prior art attempts to fabricate a combined labyrinth/brush seal, groove 16, FIG. 2 is formed in labyrinth seal 10 in the process removing one or more existing teeth and complete brush seal assembly 20, FIG. 3 is placed therein including back plate 22, front plate 24, and bristle pack 26 sandwiched therebetween. In U.S. Pat. No. 6,257,568, back plate 22′, FIG. 4 of brush seal assembly 20 is specially formed to have the profile of a tooth removed from labyrinth seal 10, FIG. 5.

As stated in the Background section above, these labyrinth/brush seal combinations have not gained wide acceptance in the industry primarily because labyrinth seals of different configurations each require different brush seals which must be specially manufactured at a great cost. The back plate of the brush seal with the profile tip set at an appropriate clearance to ensure brush seal performance characteristics requires a specific brush seal design for each labyrinth seal application. The same is true with respect to the front plate of the brush seal: it must have an appropriate amount of clearance both axially relative to the bristle pack and radially to the seal inside diameter. The front and back plate features, when joined to the bristle pack, result in a curved segment with sufficient bending rigidity to make it impractical to apply to a range of labyrinth seal housing diameters. Thus, in the prior art, each brush seal is custom designed and targeted to a specific application.

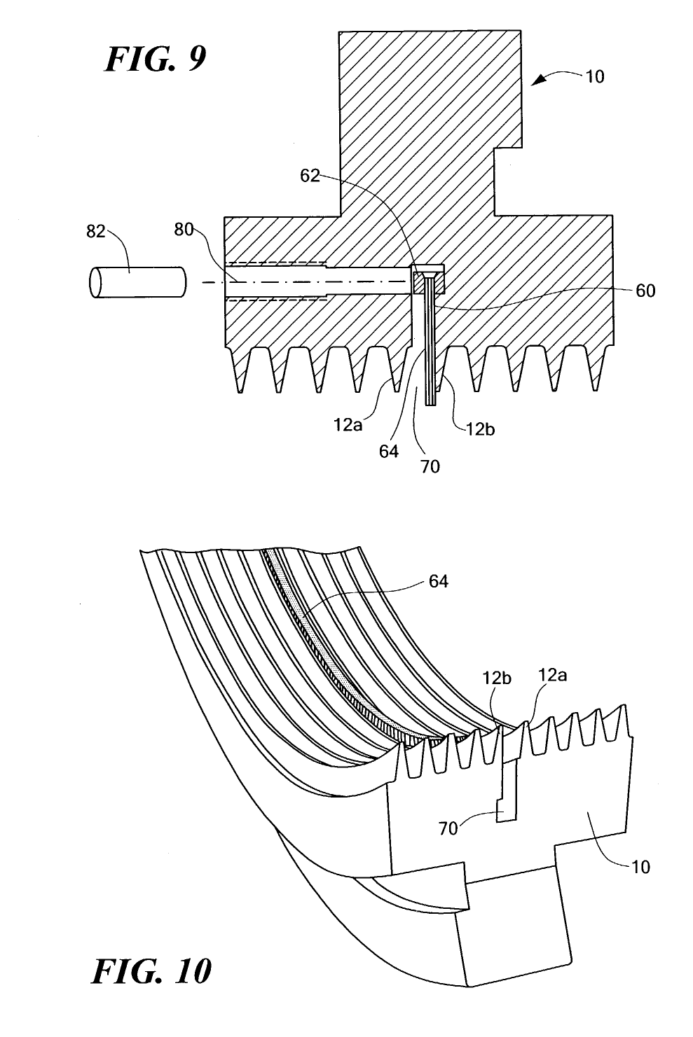

In the subject invention, in contrast, brush seal 60, FIG. 6 which includes retainer 62 and bristles 64 extending therefrom is preferably devoid of a front and back plate and thus the high cost associated with manufacturing brush seals of different configurations for different labyrinth seal designs is eliminated.

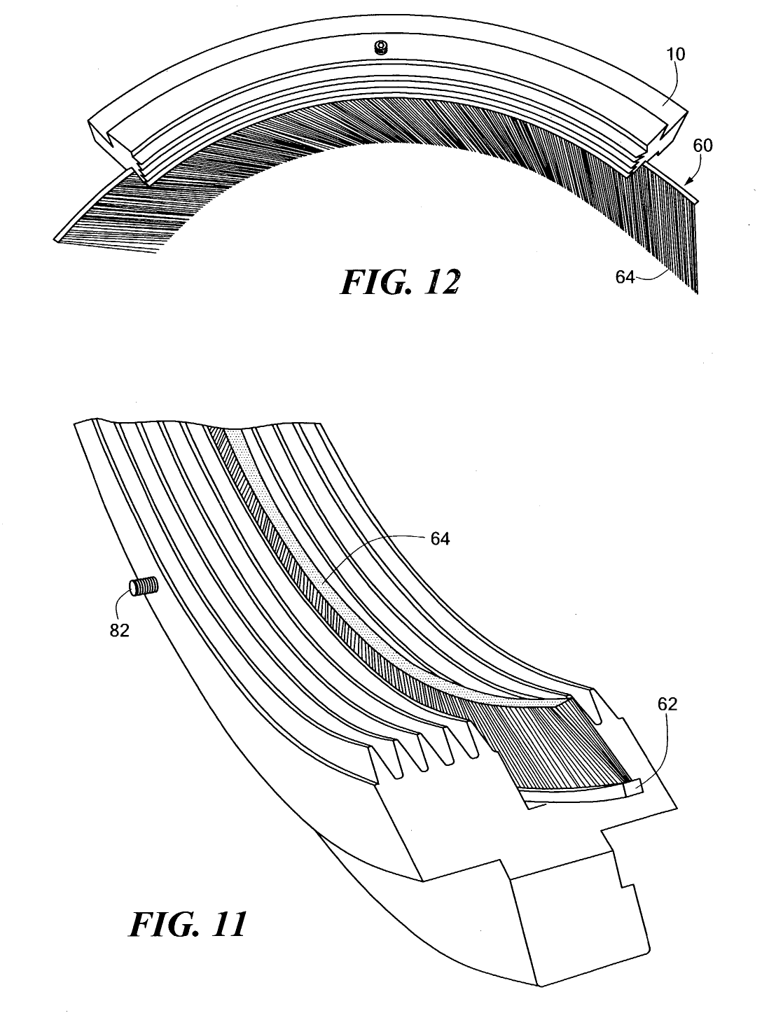

In accordance with one embodiment of the method of this invention, labyrinth seal 10, FIG. 7 is machined to include slot 70, FIG. 8 between adjacent teeth 12a and 12b preferably removing a portion of tooth 12b forming a straight back plate for the bristles 64 of the brush seal as shown in FIG. 9. Slot 70 is thus defined by first and second parallel walls 80 and 82 and also includes offset 84, FIG. 8 extending over tooth 12b. When retainer 62, FIG. 9 is positioned in offset 84, the bristles of the brush seal abut tooth 12b but are spaced from tooth 12a.

In this way, existing tooth 12a of labyrinth seal 10 forms the front plate of the brush seal 60 and adjacent tooth 12b forms the back plate of brush seal 60 and, at the same time, the functionality of existing labyrinth seal teeth 12a and 12b are retained.

Threaded channel 80 may also be formed in labyrinth seal 10 to receive threaded pin 82 which removably retains brush seal 60 in slot 70 of labyrinth seal 10 although other retaining mechanisms may be used. In this way, brush seal 60 can be replaced if necessary.

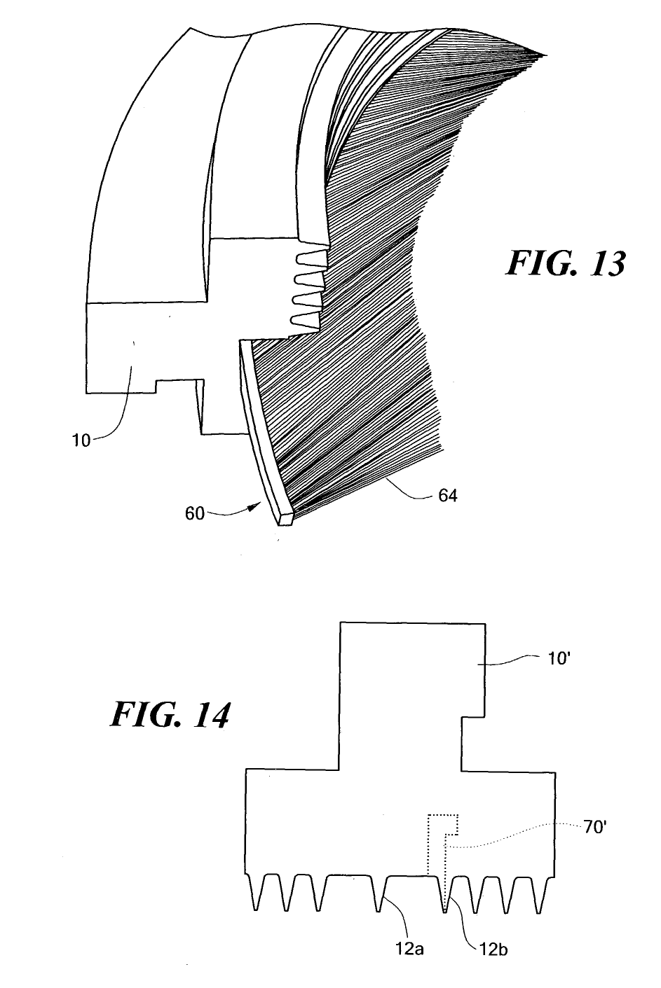

FIG. 10 depicts the prototype design of this invention showing slot 70 between teeth 12a and 12b and bristles 64 extending outward from teeth 12 better shown in FIG. 11 which also shows threaded retaining pin 82 partially inserted. FIGS. 12-13 shown brush seal 60 in place in labyrinth seal 10 before bristles 64 are trimmed so that they either just contact the rotor or are slightly set back there from in accordance with U.S. Pat. No. 6,250,640.

Typically, the brush seal design of U.S. Pat. No. 6,231,047 is used and the retaining element has a moment of inertia of 5×10⁻in.⁴ or less as discussed therein, although this is not a limitation this invention.

One aspect of the subject invention is that a single brush seal assembly configuration can be used in conjunction with a wide variety of labyrinth seal types found in the industry and no front or back plates need be fabricated resulting in a lower cost labyrinth/brush seal combination for labyrinth seals already in use or for newly fabricated seals to be put into service.

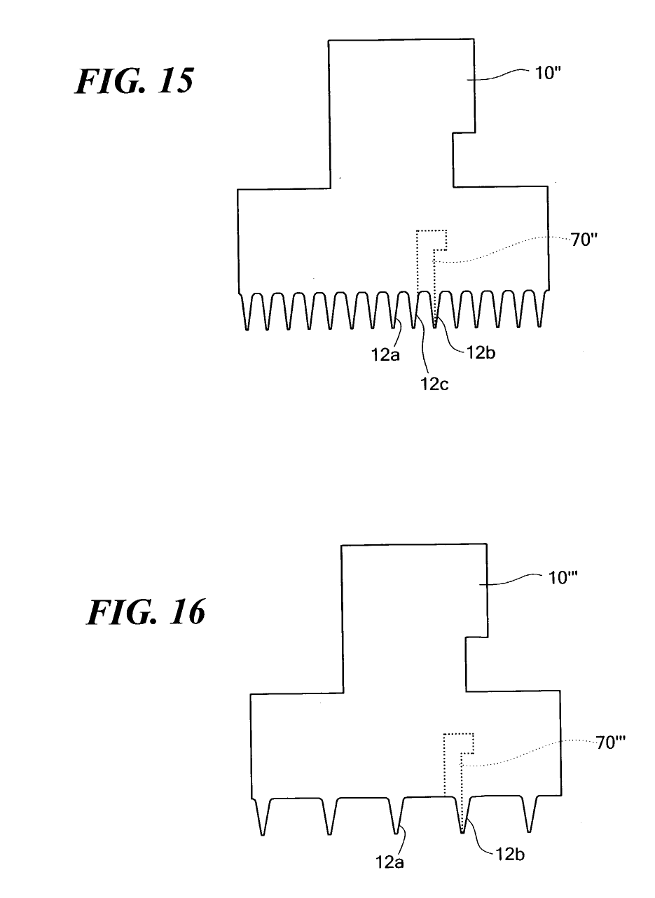

For example, in FIG. 14, slot 70′ is formed in labyrinth seal 10′ between adjacent teeth 12a and 12b removing a portion of tooth 12b as discussed above. In FIG. 15, slot 70″ in labyrinth seal 10″ is formed by completely removing tooth 12c while remaining adjacent teeth 12a and 12b form the front and back plates, respectively, of the brush seal. In FIG. 16, labyrinth seal 10′″ has teeth 12a and 12b spaced further apart than in the design of FIG. 15 but still slot 70′″ is formed therebetween rendering tooth 12b straight on the inner side thereof for the bristles of the brush seal. Thus, for any labyrinth seal design 10′ through 10′″, FIGS. 14-16, a single brush seal configuration 60, FIG. 6 can be used.

Once the location of the brush seal is established, one labyrinth seal tooth is chosen as the back plate and machined flat as discussed above. Recess 84, FIG. 8 is then formed and width w₁ is established to accommodate width w₂, FIG. 6, of retainer 62. One typical retainer width w₂ is 0.180 inches. Typically, width w₁ is less than or equal to the space between adjacent labyrinth teeth (FIGS. 14 and 16) and thus, because there is no front or back plate associated with the brush seal, no labyrinth teeth need be cut out to accommodate them. In this way, the full functionality of the labyrinth seal teeth is retained. There may be designs, however, as shown in FIG. 15, where width w₁ is greater than the spacing between adjacent labyrinth seal teeth and one or more labyrinth seal teeth must be removed.

But, instead of a new brush seal design for each labyrinth seal configuration, and instead of requiring back and front plates for the brush seal with the appropriate of clearances and profiles, a better labyrinth/brush seal combination is effected in this invention by using the existing adjacent labyrinth seal teeth to serve as the front and back plates of the brush seal so that a single brush seal design or only a relatively few brush seal designs can be used in connection with many different labyrinth seal configurations to greatly reduce the cost of labyrinth/brush seal combinations.

In other designs, the pressure balancing features disclosed in U.S. Pat. No. 5,401,036 may be incorporated with the labyrinth/brush seal combination of this invention. Also, the retractable designs known in the art can be incorporated to minimize the brush seal and labyrinth seal teeth wear that typically occurs during startup and shut down.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A labyrinth/brush seal combination comprising:
a brush seal including a retainer and a plurality of bristles extending therefrom;
a labyrinth seal including a plurality of teeth and a slot formed between adjacent teeth;
the retainer of the brush seal disposed in the slot formed in the labyrinth seal;
a first tooth of the labyrinth seal forming the front plate of the brush seal; and
a second, adjacent tooth of the labyrinth seal forming the back plate of the brush seal.

2. The labyrinth/brush seal combination of claim 1 in which the retainer has a moment of inertia of approximately 5×10⁻⁵ inches⁴ or less.

3. The labyrinth/brush seal combination of claim 1 in which the bristles abut the second tooth and are spaced from the first tooth.

4. The labyrinth/brush seal combination of claim 1 further including a pin extending into the labyrinth seal for removably securing the retainer of the brush seal in the slot.

5. The labyrinth/brush seal combination of claim 1 in which the slot defines first and second parallel walls, the second parallel wall overlapping the second tooth forming a straight back plate.

6. The labyrinth/brush seal combination of claim 5 in which the slot terminates in an offset extending over the second tooth to position the bristles in an abutting relationship with the second tooth.

7. The labyrinth/brush seal combination of claim 1 in which the bristles extend outward from the first and second teeth.

8. The labyrinth/brush seal combination of claim 1 in which the slot has a width less than or equal to the space between adjacent labyrinth teeth.

9. The labyrinth/brush seal combination of claim 1 in which the slot has width greater than the space between adjacent labyrinth teeth.

10. A labyrinth/brush seal combination comprising:
a brush seal including a retainer having a moment of inertia of approximately 5×10⁻⁵ inches⁴ or less and a plurality of bristles extending therefrom;
a labyrinth seal including a plurality of teeth and a slot formed between adjacent teeth;
the retainer of the brush seal disposed in the slot of the labyrinth seal; and
one existing tooth of the labyrinth seal forming the back plate of the brush seal.

11. A labyrinth/brush seal combination comprising:
a brush seal including a retainer and a plurality of bristles extending therefrom;
a labyrinth seal including a plurality of teeth and a slot formed between adjacent teeth;
the slot defining first and second parallel walls, the second wall overlapping one tooth of the labyrinth seal forming a straight back plate for the bristles of the brush seal, the slot terminating in an offset extending over said tooth; and
the retainer of the brush seal disposed in the slot of the labyrinth seal and the bristles of the brush seal abutting said tooth.

12. A method of making a labyrinth/brush seal combination, the method comprising:
forming a slot between first and second teeth of a labyrinth seal;
assembling a brush seal to include a retainer and a plurality of bristles extending therefrom but lacking a front or back plate; and
disposing the retainer of the brush seal in the slot so that the first tooth of labyrinth seal forms the front plate of the brush seal and the second tooth of the labyrinth seal forms the back plate of the labyrinth seal.

13. The method of claim 12 in which the retainer is designed to have a moment of inertia of approximately 5×10⁻⁵ inches⁴ or less.

14. The method of claim 12 in which the bristles are made to abut the second tooth and to be spaced from the first tooth.

15. The method of claim 12 further including the step of forming a channel in the labyrinth seal and placing a pin in the channel for securing the retainer of the brush seal in the slot.

16. The method of claim 12 in which forming the slot includes cutting the second tooth of the labyrinth seal to form a straight back plate for the brush seal.

17. The method of claim 16 in which forming further includes machining an offset extending over the second tooth.

18. A method of making a labyrinth/brush seal combination, the method comprising:
forming a slot between adjacent teeth of a labyrinth seal, assembling a brush seal to include a retainer having a moment of inertia approximately 5×10⁻⁵ inches⁴ or less and a plurality of bristles extending therefrom but lacking a back plate; and
disposing the retainer of the brush seal in the slot so that an existing tooth of the labyrinth seal forms the back plate of the brush seal.

19. A method of making a labyrinth/brush seal combination, the method comprising:
forming a slot between adjacent teeth of a labyrinth seal and cutting one said tooth to form a straight back plate;
assembling a brush seal to include a retainer and a plurality of bristles extending therefrom but lacking a back plate; and
disposing the retainer of the brush seal in the slots so that the bristles of the brush seal abut the cut second tooth of the labyrinth seal.
